(19) United States
(12) Patent Application Publication
(10) Pub. No.: US 2007/0158413 A1
(43) Pub. Date: Jul. 12, 2007

(54) Defined purchase instrument and method for use

(76) Inventor: Christine Wade Hastie, Cincinnati, OH (US)

Correspondence Address: JOHN B. WOODARD, 8657 TWILIGHT TEAR LANE, CINCINNATI, OH, 45249, US

(21) Appl. No.: 11/650,738

(22) Filed: Jan. 8, 2007

Related U.S. Application Data
(60) Provisional application No. 60/757,363, filed on Jan. 9, 2006.

(51) Int. Cl. G06K 5/00

(52) U.S. Cl. 235/380

(57) ABSTRACT

A defined purchase instrument and method for controlling spending is provided which uses defined conditions chosen by a purchaser of a defined purchase instrument to provide limitations on the use of the defined purchase instrument. The defined purchase instrument is a financial instrument that can be used by a holder of the instrument to purchase goods and services. The defined purchase instrument can define a particular set of vendors and can define a set of purchase conditions for which that particular defined purchase instrument can be used. The defined purchase instrument cannot be used for other vendors or for conditions other than those defined by the purchaser of the defined purchase instrument.

This application claims the benefit of co-pending U.S. Provisional Patent Application No. 60/757,363 filed Jan. 9, 2006.

### BACKGROUND OF THE INVENTION

Because of convenience, ease of use, and ready access to credit, among other benefits, the use of credit cards and similar financial instruments to purchase goods and services has become common in the marketplace. However, credit cards come with few limitations of use. Usually, the only limitation is a spending limit corresponding to total credit available. This limitation is assigned by the credit card provider and is usually based on the credit worthiness of the credit card user.

The few limitations associated with most credit cards, debit cards, and similar financial instruments limit the usefulness of such instruments when attempting to control spending. For example, a person who has poor self control when shopping can easily purchase things that the person does not need or make purchases that are frivolous using a credit card to buy by using their line of credit. It would be much more convenient if that person were able to place limitations on his or her financial instrument, in this instance a credit card, before the person became tempted to make purchases available while actually shopping. The desired limitations could be variable depending on the individual who is shopping. As another example, a person could place limitations in terms of the category of item that can be purchased, merchant or vendor qualified to sell to the person, price of any one individual purchase, the amount allocated to any one vendor, or other limitations of use for any particular financial instrument.

In a further example, parents and other interested parties are often highly supportive of students who are about to attend or who are already attending college. Often, parents provide a support structure that extends across a broad range to help sustain students in their endeavors. This can encompass activities from moral support to financial gifting and other forms of financial support and can include other kinds of support as well. However, supporters of students are often concerned about the activities in which their students are participating while in school. Such supporters would like to make sure that support they give, especially financial support, is used in a manner of which the supporters approve.

Students, on the other hand, often need help in matters of judgment, especially, when they depart home. Sometimes the freedoms that students enjoy when away from home are difficult to deal with, and the concerns of the parents are justified. The students do need help with the life style decisions that they make when at school.

While parents and others want to be supportive, they want to be sure that their student has everything needed to enjoy college life without encouraging their student to engage in activities of which the parents do not approve. Consequently, parents would prefer to give gifts to students that have some limitation of use. For example, a gift of cash to a student has no limitations, and the student can spend the cash in any way she or he wants. There are other kinds of gifts that do come with limitations of use and that parents would feel more comfortable giving to students. Among these are physical or intellectually based gifts that have a use or purpose, gift certificates, and gift cards.

While parents can easily provide the physical or intellectual gifts in the form of products or other gifts from home, there is no convenient way for parents to obtain a broad range of limited use gifts available near the school location for their students to choose when in school. In particular, there is no convenient way to provide spending capabilities for students at school that are likely to meet with the parents' approval.

The above are examples of a plurality of needs that go unfulfilled in the marketplace. Financial instruments that can be limited in a variety of ways are needed.

### BRIEF DESCRIPTION OF THE INVENTION

A defined purchase instrument is provided for controlling spending. The defined purchase instrument has several features. They include an identifiable account for tracking a money balance of the defined purchase instrument. In addition the defined purchase instrument has at least one defined condition that can be selected by the purchaser of the defined purchase instrument at the time of purchase under which the defined purchase instrument is valid for use. The defined condition provides limitation on use of the defined purchase instrument for making purchases, and the defined purchase instrument is valid for making a purchase only when the defined condition is met.

A defined purchase instrument for allowing parents to control purchases by college students is provided. The system comprises an identifiable account for tracking the money balance of the defined purchase instrument. The defined purchase instrument has at least one defined condition chosen by a parent purchaser at the time of purchase of a defined purchase instrument. These choices define the conditions under which the defined purchase instrument is valid and provide limitations on the use of the defined purchase instrument. In use the defined purchase instrument is valid for making purchases only when the defined conditions representing the limitations of use are met.

A method is established for providing a defined purchase instrument to a recipient and for providing a system whereby the recipient can spend the value represented by the defined purchase instrument. The defined purchase instrument is valid for purchasing from at least one vendor based on limitations selected by the purchaser. The method is to first determine selection criteria that can be used to select vendors appropriate for the defined purchase instruments to be offered. Following this, a group of vendors meeting the selection criteria is formed. Each vendor agrees to adhere to a defined purchase instrument validation system, and a defined purchase instrument payment system is established with each vendor. In addition a defined purchase instrument account tracking system is established with each vendor. A system whereby a purchaser can purchase and select the criteria or limitations under which a particular defined purchase instrument is to be used and whereby vendors can be selected is established. Also, a system for the purchaser to pay for her/his purchase and a system for delivering the defined purchase instrument to the recipient are provided.

### BRIEF DESCRIPTION OF THE DRAWINGS

FIG. 1 depicts a purchase process according to one embodiment of the invention.

FIG. 2 depicts a purchase process according to one embodiment of the invention.

FIG. 3 depicts a purchase process according to one embodiment of the invention.

FIG. 4 depicts a selection process according to one embodiment of the invention.

### DETAILED DESCRIPTION OF THE INVENTION

The defined purchase instrument is a financial instrument that can be used by a holder of the instrument to purchase goods and services. Defined purchase instruments comprise special types of prepaid accounts, credit accounts, prepaid or credit line voucher accounts, number identified accounts, bar code accounts, radio frequency device accounts identified by radio frequency devices, wireless device based accounts, or other accounts. All the accounts have an account identifier method which allows the holder of the defined purchase instrument to purchase goods or services from one or more defined vendors. In addition, the accounts all have methods by which account balances can be kept up to date and tracked. The defined purchase instrument can define a particular set of vendors and can define a set of purchase conditions for which that particular defined purchase instrument can be used. The defined purchase instrument cannot be used for other vendors or for conditions other than those defined by the purchaser of the defined purchase instrument.

Vendors are any entity willing to exchange goods and/or services for compensation, including compensation through the use of a defined purchase instrument. The vendors can be merchants, service providers, or any other provider of goods and/or services. To use the defined purchase instrument there need not be, but can be, business or other relationships among vendors.

A website can be employed from which defined purchase instrument suppliers can distribute defined purchase instruments. The defined purchase instrument and its uses can be described on the website, and the website can describe the defined purchase instrument uses, controls, limitations, and disclaimers. It can allow buyers and receivers to monitor defined purchase instrument accounts. It can list groups of vendors from which buyers can select at least one, and it can list various receiver gift registries. The defined purchase instruments can also be secured through other methods comprising purchase through direct contact sales, retail establishments or response to print or electronic advertising in media such as newspapers, mailers, other publications, radio, or television advertisements.

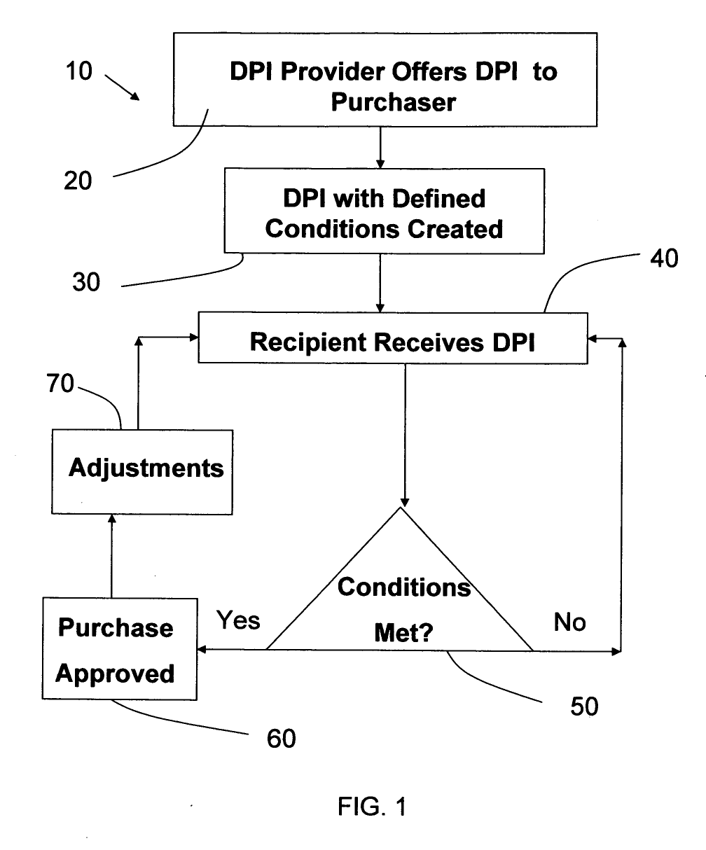

FIG. 1 is a drawing 10 showing one embodiment of the way that a defined purchase instrument, denoted in the drawings by the letters, DPI, can be created and used. In the embodiment shown, the defined purchase instrument provider 20 offers the defined purchase instrument to a purchaser and the purchaser defines the conditions under which the defined purchase instrument will be valid for use. The defined purchase instrument 30 is then received by the recipient 40. The recipient 40 can be the purchaser or some other recipient 40. The recipient 40 then decides to use the defined purchase instrument 30. To be used a decision 50 must be made of whether or not the conditions defined by the purchaser for use have been met. If the conditions 50 are not met, the defined purchase instrument is returned to the recipient 40, and no purchase is made with the defined purchase instrument. If the conditions defined by the purchaser of the defined purchase instrument are met, the purchase 60 is approved. Any adjustments 70 that need to be made to the defined purchase instrument 30, depending on the nature of the defined purchase instrument account, are made, and the recipient receives the adjusted defined purchase instrument 40.

The defined purchase instrument 30 can take on several different characteristics. Some of these employ a voucher form wherein a voucher is taken to a vendor, and the voucher is used to pay for a purchase. In one embodiment gift certificates can be defined purchase instruments 30 in voucher form and can permit the bearer of the gift certificate to receive the stated value of the gift certificate in prepaid products or in prepaid services from a vendor. The gift certificate can be single use for a fixed amount of value at a single vendor or can be provided in a form which allows multiple use and multiple charges up to a total dollar value amount through a single vendor or through a plurality of vendors.

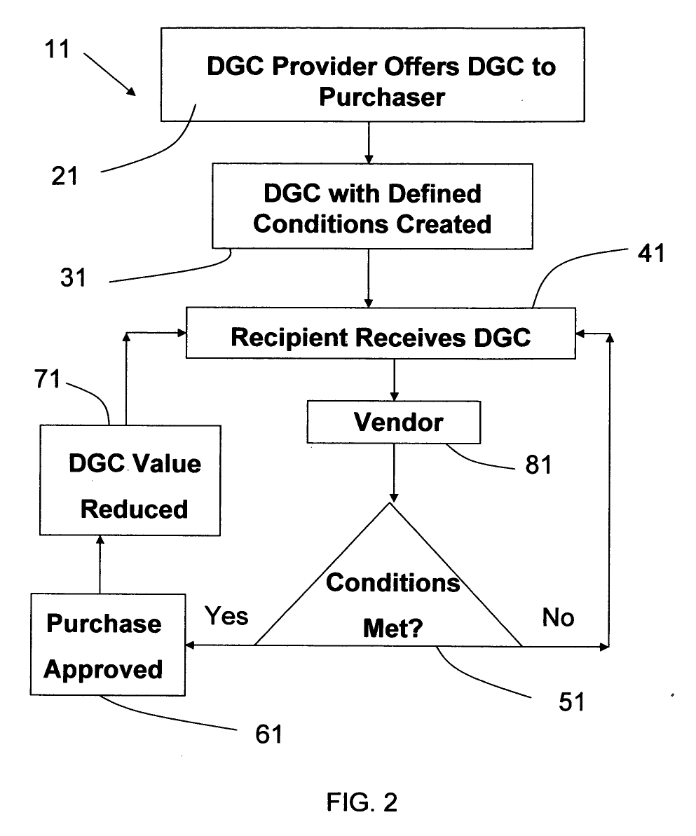

Another embodiment is debit gift cards that can be defined purchase instruments 30 in voucher form which permit the bearer of the voucher to receive prepaid products or prepaid services from a vendor. Referring to FIG. 2, the drawing 11 shows how a debit gift card, denoted by the letters DGC in the figure, can be applied using the invention. A DGC provider 21 sells a debit gift card with defined conditions 31 limiting its use, to a purchaser. The purchaser has chosen the defined conditions 31. The debit gift card provider then provides the card to a recipient 41, whether that recipient 41 is the purchaser or some other recipient 41. The value of the debit gift card can be depleted in one or more transactions, and the debit gift card is good for a specified dollar amount. The recipient 41 decides to use the debit gift card to make several different purchases and takes the card to a vendor 81 to make a purchase. The vendor 81 determines 51 through inquiry into a data base if the defined conditions 31 are met for the purchase desired by the recipient 41. If the conditions 51 are not met, the vendor 81 simply returns the debit gift card to the recipient 41 without changing anything. If the vendor 81 finds that the defined conditions 31 are met, he approves the purchase 61 and is able to reduce the value 71 of the debit gift card 31 in the amount of the purchase. This process continues as each desired purchase is made until the debit gift card 31 has no remaining value.

The debit gift card 31 value 71 can be adjusted and accounted for in various ways so that the gift card retains the correct amount of value as the cost of purchases is deducted. In this embodiment it functions as a prepaid card wherein the purchaser of the card, who after purchase becomes the recipient 41 of the card, adds value to the debit gift card account by paying for the card with money prior to spending the value of the card.

In another embodiment the defined purchase instrument 30 can function more like a credit card but with spending limits assigned to each vendor in a group of vendors so that the holder cannot spend all of their money with one vendor. In the latter case the amount of credit used is subsequently billed to the user as it would be with a regular credit card.

In yet another embodiment, the defined purchase instrument's 30 value can be used in partial increments at all of the defined vendors, or all the value can be spent at just one of the defined card vendors. For example, with a $500 defined purchase instrument 30 valid for vendors A, B, C, D, E, and F, the recipient could spend $250 at vendor A on the second day of ownership, $100 at vendor B three weeks later, $50 at vendor C a week later and $100 back at vendor B five months later. Here the recipient did not exercise the option to spend any part of the card at vendors D, E, or F, which were also valid vendors where the instrument could be accepted. The recipient of the instrument also had the option to spend the entire $500 card at any one of the vendors A through F, which had been pre-selected by the defined purchase instrument 30 purchaser.

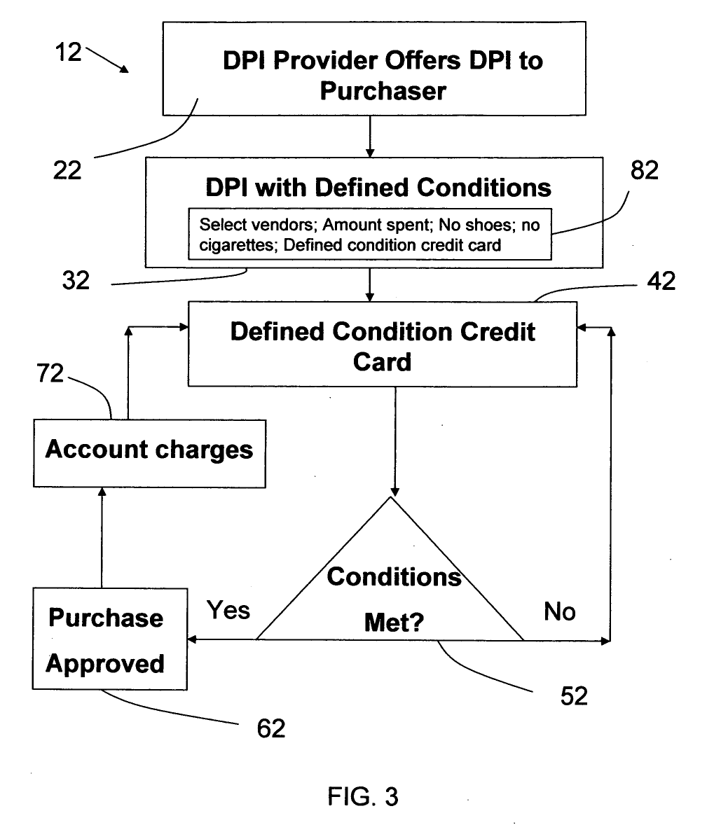

In another embodiment users can use the defined purchase instrument 30 to help them exercise self control when in an actual purchasing situation. They can use the defined purchase instrument 30 so that they can only purchase items at the stores and in the limits that they had previously authorized for themselves. For example, a shopper might have trouble controlling his purchases when shopping. That person can use the defined purchase instrument 30 to control spending by purchasing a defined purchase instrument 30 before going shopping and taking only their defined purchase instrument 30 with them to pay for purchases. FIG. 3 shows a process 12 for accomplishing this. The purchaser goes to a provider 22 of defined purchase instruments 30 and purchases a defined purchase instrument 32 with the defined conditions that they desire. In the case shown, the purchaser selects conditions 82 that are offered by the defined purchase instrument provider 22. The selected conditions 82 are based on choosing only certain vendors, limiting the amount spent with each vendor, and not allowing purchase of shoes or cigarettes. In addition the purchaser 32 chooses a defined condition credit card to make purchases. In this embodiment the purchaser has modified an existing credit card account 42 to accept only charges that meet the limitations of the defined conditions chosen 82, and the purchaser can now purchase only according to the defined conditions 82 chosen for the credit card.

The purchaser then uses the card at the selected vendors. If all the conditions 52 that the purchaser defined are met, the purchaser can make purchases 62. As purchases 62 are made, account charges 72 are made to the purchaser's credit card account, and the purchaser can continue making charges to the defined purchase instrument 42 until one of the defined conditions 82 is violated. If the conditions 82 are not met, the purchaser cannot make a purchase with the credit card, and the vendor returns the credit card to the purchaser.

There are other applications for the defined purchase instrument. In one embodiment a person is married to a spouse with a gambling problem. The spouse with the gambling problem is not employed. The working spouse wants his or her partner to have money for all essentials. The working spouse selects a defined purchase instrument that can be periodically reloaded with additional purchasing power and validates it for only the vendors that the person believes to be appropriate for their spouse.

In another embodiment a business has employees who must travel regularly to a certain city. The traveling employees are on a per diem account. The business has worked out discounts at certain hotels and knows the other goods and services needed by a traveling employee. Because the company no longer wants the employee or their accounting office to take the time to assemble traveling receipts, the business defines the conditions of validity of the defined purchase instrument 30, in this case a chargeable card, for the employee. The company selects the conditions of validity which are in this case the maximum per diem and the names of hotels, restaurants, rental car services, and airport parking where the employee can use the card. They provide the employee with cash for tips and out of pocket expenses and avoid having to deal with individual receipts.

In another embodiment a company wants to improve the health of its employees by promoting exercise. To accomplish this they give each employee a defined purchase instrument that is only good toward membership or admission at several different fitness clubs or tennis clubs in their area.

Other users can use the defined purchase instrument 30 to provide gifts to others with customized limitations. Some of these can involve gift registries for the receivers. In one embodiment a wedding couple has registered at three unrelated retail store vendors. Short on time, the buyer wants to spend a limited amount on a gift for the couple. Using the internet to look through their various registries, the buyer can find nothing in her price range. She decides to give the couple a defined purchase instrument good for use at any of the three retailers at which the couple is registered. She then goes to a website offering defined purchase instruments to purchase one for them that allows the couple to spend part of their gift or their entire gift at any one or any combination of the vendors.

In yet another embodiment, kiosks are loaded with a defined purchase instrument vendor package for an area, a particular city, a particular state, or specific cities or regions. The purchaser selects from the kiosk the area, city, state, country, or region and selects the vendors for the defined purchase instrument. The purchaser then enters her credit card and selects the desired gift value. The card is either generated at the kiosk for the purchaser, or it can be delivered to another recipient. For example, the gift card could be mailed to a recipient by an electronic fulfillment service via recipient information entered at the kiosk.

The kiosks could be in a mall and identify only mall stores as vendors. Alternatively, the kiosks could be in a store where the purchaser goes for other purposes, as, for example, a grocery store. The kiosks could also be located at an independently leased kiosk center that exists specifically for the purpose of selling the defined purchase instrument for use in a selected geographical area.

From the above it can be seen that the defined purchase instrument can be used as a gift card allowing the receiver multiple vendor options. The gift card can be given as a gift which allows the giver to control the receiver's spending while giving the receiver multiple vendor options that the giver deems appropriate for the receiver's age or circumstances. The card can be given as a one time use card or as a card that can be reloaded at the giver's will.

An example of this can occur when students are away from home at school. In this embodiment the invention permits parents and other interested parties to provide college gift certificates, which are college related gift in some way, debit gift cards or other kinds of defined purchase instruments to students while retaining some control over the manner of use of the gifts. Herein, the term parent is used to include any party who wants to support or make gifts to students.

Control is accomplished by providing parents the ability to choose at least one establishment from a plurality of establishments where the defined purchase instrument can be used. The choice of vendor or vendors is made from a listing of vendors provided by the seller of the defined purchase instruments which satisfies certain selection criteria. For example, the list could contain vendors all located within a defined distance from a particular college campus and could be limited to vendors who do not sell alcohol containing products. The method provides parents a way of securing defined purchase instruments, represented in this case by gift certificates, for their students from an appropriate selection of vendors without having to travel to the campus or visiting each vendor individually.

In this embodiment a website is used from which parents can purchase defined purchase instruments such as gift certificates, debit gift cards, or other vouchers valid with various merchants or other vendors that the parents select on line. The vouchers can also be secured through other methods comprising purchase through a retail establishment or response to print or electronic advertising in media such as newspapers, other publications, mailings, radio, and television advertisements.

Comprising a method for supplying defined purchase instruments such as gift certificates, debit gift card, or other payment vouchers for potential or existing students, the invention provides validated vouchers for use only at the vendors chosen by the parents and in the amounts specified. For example, by choosing carefully, the parents can insure that the valid merchant establishments are in the vicinity of their student's educational institution.

From another aspect one way of practicing the invention is for a defined purchase instrument provider to contact vendors in the vicinity of schools and to make arrangements with them to accept vouchers in a form acceptable to the vendors. Since the invention is designed so that sales of participating vendors are enhanced by practicing the invention, the vendors agree to accept the defined purchase instruments and compensation arrangements are made.

For example, a participation fee can be charged to vendors for their participation in the business method; a charge can be made in the form of a discount to the seller of the gift certificate, debit gift card or other voucher; a charge can be made in the form of a surcharge to the vendor for an amount related to the value of the defined purchase instrument; or some other arrangement can be made between the gift seller and the vendor. Various other methods, including but not limited to an activation fee, shipping and handling fee, a gift wrap fee, a reload fee, a negotiated portion of the bank fee, an annual negotiated payment from the bank based on annual usage, an annual participation fee, or a one time membership fee, in any combination or individually can be used to secure payment for the service provided by the seller of the defined purchase instruments.

In other embodiments, various promotional arrangements can be made between defined purchase instrument providers and vendors. For example, offers can be made to vendors allowing them to purchase advertising or other promotional representation in the media used by the defined purchase instrument seller, for the purpose of enhancing vendor sales. For example, a particular vendor in the vicinity of a college could purchase an advertisement that appears on the home page of a website offering gift certificates valid at individually selectable vendors. This could be done to enhance the likelihood that parents will choose the vendor based on the vendor's advertisement or for other marketing reasons.

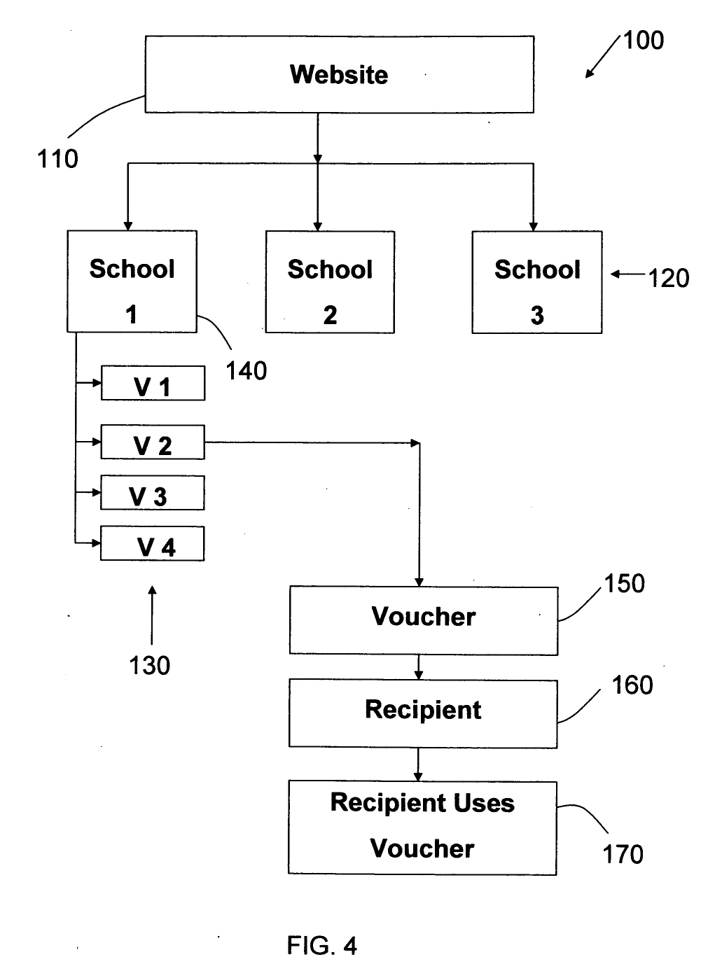

Referring to FIG. 4, in one embodiment, when the invention is practiced online or using a website 100, the purchaser visits the website 110 which lists the names of schools 120 and other educational institutions which students attend. In FIG. 4 only three schools 120 are shown, but any number of schools 120 or educational institutions could be available for choice on the website 110. Clicking on one of the schools 120 opens a list of vendors 130, denoted in FIG. 4 by V 1, V 2, V 3, and V 4 which are located in the vicinity of the school or are otherwise accessible by students. In the drawing only four vendors 130 are shown, but any number of vendors 130 could be included so long as they meet the defined criteria set in this case by the provider of defined purchase instruments. In this embodiment the purchaser has decided on only one vendor, but could have chosen any combination of the vendors 130. The purchaser then selects the single vendor where he or she would like a purchased defined purchase instrument to be valid. In this case the purchaser has chosen the defined purchase instrument to be a voucher 150 that is valid only with one vendor. The purchaser then selects a face value for the voucher 150 in terms of a dollar amount and pays for the voucher 150 purchase. In the online case, payment can be made online or can be made in other ways permitted by the website such as check by mail, bank transfer, mailed credit information or other suitable payment means.

The defined purchase instrument is delivered to the recipient 160. The recipient 160 can then use the voucher 170 to make purchases so long as the defined conditions are met. The defined conditions are the limitations governing use of the defined purchase instrument.

Delivery of defined purchase instruments such as gift certificates or debit gift cards can be made either online with suitable security means, can be made by mail, or can be made by other delivery means. For example, in one embodiment the purchaser can have a defined purchase instrument mailed directly to a student recipient.

Typical merchant establishments will comprise bookstores, entertainment ticket vendors, theaters, restaurants, transportation services, specialty stores, drugstores, home furnishing stores, video stores, salons, spas, dry cleaners, bakeries, florists, and other commercial establishments. Referring again to the case of students at school, the website can also provide vouchers for paying for various fees books, tuition, room and board, campus cultural or entertainment events, or other school provided programs, services, or hard goods.

A feature of the invention is that the purchaser can select a defined purchase instrument for only one merchant or for a specified group of merchants.

In one embodiment where the purchaser desires the recipient of a defined purchase instrument, in this case a gift certificate, to spend it with only one vendor, the purchaser simply selects the vendor from the list of vendors provided by the defined purchase instrument provider, selects a certificate amount, pays the charges, and specifies that the certificate be sent to the recipient's address, having provided that address.

In another embodiment, if the purchaser wants the receiver to be able to use a debit gift card for a wider range of purposes, the purchaser can enable the receiver to use the card for all the listed merchants.

Defined purchase instruments can be sold or administered by a variety of entities from credit card companies through banks and other institutions to entrepreneurs. Using the school embodiment as an example, the invention can be targeted to help a student pay for certain specific necessities of his studies. From this aspect the invention can be targeted at tuition or room or board. To do this the payment to be made on the student's behalf is paid directly to the school in the student's name. The school issues, and the student receives a defined purchase instrument with the purchaser's defined conditions noted. One of the defined conditions is the value of the defined purchase instrument in the amount of the gift. For example, the student is mailed a voucher showing the amount contributed and that it can only be used toward tuition or room or board and the purchaser's or contributor's name. The student then has the flexibility to apply the amount of the defined purchase instrument as he sees fit to pay for tuition or room or board. It should be noted that the purchaser can have the ability to reload the card with additional value as desired.

Those skilled in the art will realize that this invention is capable of embodiments different from those shown and described. It will be appreciated that the detail of the structure of the defined purchase instrument and the methodology can be changed in various ways without departing from the scope of this invention. Accordingly, the detailed description of the invention and embodiments are to be regarded as including such equivalents as do not depart from the scope of the invention.

1. A defined purchase instrument for controlling spending, the defined purchase instrument comprising:
an identifiable account for tracking a money balance of the defined purchase instrument;
the defined purchase instrument having at least one defined condition under which the defined purchase instrument is valid for use;
the defined condition being selectable by a purchaser of the defined purchase instrument at the time of purchase;
the defined condition limiting the use of the defined purchase instrument for making purchases; and
the defined purchase instrument being valid for making a purchase only when the at least one defined condition is met.

2. The defined purchase instrument of claim 1 wherein the defined condition chosen by the purchaser to limit use of the defined purchase instrument comprises limitation based on at least one of the following:
selection of vendor;
selection of defined purchase instrument value;
selection of at least one purchasable thing that can be purchased using the defined purchase instrument;
selection of geographical locations where the defined purchase instrument is valid; and
selection of kind of defined purchase instrument account.

3. The defined purchase instrument of claim 1 wherein the defined purchase instrument possesses characteristics of at least one of the following:
gift certificate;
debit gift card; and
credit card.

4. The defined purchase instrument of claim 1 wherein the defined purchase instrument is accounted for as at least one of the following kinds of accounts:
prepaid account;
credit account;
credit line voucher account;
bar code account;
radio frequency device account;
wireless device based account; and
number identified account.

5. The defined purchase instrument of claim 1 wherein the defined purchase instrument is part of a system for controlling spending comprising:
a provider of the defined purchase instrument;
a distribution arrangement for selling the defined purchase instrument; and
a system to accept the defined purchase instrument as payment for purchases.

6. A defined purchase instrument for allowing a parent to control spending by a college student comprising:
an identifiable account for tracking a money balance of the defined purchase instrument;
the defined purchase instrument having at least one defined condition under which the defined purchase instrument is valid for use;
the defined condition being selectable by a parent purchaser of the defined purchase instrument at the time of purchase;
the defined condition defining limitation on use of the defined purchase instrument for making purchases; and
the defined purchase instrument being valid for making a purchase only when the defined condition is met.

7. The defined purchase instrument of claim 6 wherein the defined conditions chosen by the parent purchaser to limit use of the defined purchase instrument comprises limitation based on at least one of the following:
selection of vendor;
selection of defined purchase instrument value;
selection of at least one purchasable thing that can be purchased using the defined purchase instrument;
selection of geographical locations where the defined purchase instrument is valid; and
selection of kind of defined purchase instrument account.

8. The defined purchase instrument of claim 6 wherein a website is used to distribute the defined purchase instruments and the website provides information about each vendor with whom the defined purchase instrument is valid.

9. The defined purchase instrument of claim 6 wherein the defined purchase instrument is part of a system for controlling spending comprising:
a provider of the defined purchase instrument;
a distribution arrangement for selling the defined purchase instrument; and
a system to accept the defined purchase instrument as payment for purchases.

10. A method for providing a defined purchase instrument to a recipient and for providing a system whereby the recipient can spend the value represented by the defined purchase instrument, the defined purchase instrument valid for purchasing from at least one vendor based on at least one defined condition selected by the purchaser, comprising:
determining selection criteria for selecting vendors;
establishing a group of vendors meeting selection criteria;
establishing a defined purchase instrument validation system with each vendor;
establishing a defined purchase instrument payment system with each vendor;
establishing a defined purchase instrument account tracking system;
providing a defined purchase instrument purchasing system for the defined purchase instrument purchaser;
establishing selections for the purchaser to choose from;
establishing a payment system for the purchaser to pay for the defined purchase instrument; and
establishing a system for delivering the defined purchase instrument to the recipient.

11. The method of claim 10 further comprising limiting vendors chosen to those located within a geographical region determined by the selection criteria.

12. The method of claim 11 wherein the geographical region extends out a specified distance from the perimeter of a campus of an educational institution and includes the campus.

13. The method of claim 12 allowing exceptions to the extended perimeter limit based on transportation availability.

14. The method of claim 10 wherein the vendor is an educational institution.

15. The method of claim 10 wherein the defined purchase instrument is a gift certificate.

16. The method of claim 10 wherein the defined purchase instrument is a debit cash card.

17. The method of claim 10 wherein the recipient is a student of an educational institution.

18. The method of claim 10 wherein the defined purchase instrument ordering source is a website.

19. The method of claim 10 wherein the defined purchase instrument ordering source is a printed advertisement.

20. The method of claim 10 wherein vendors can purchase advertisements in media associated with the defined purchase instrument ordering source.
